(19) United States
(12) Patent Application Publication
(10) Pub. No.: US 2026/0100447 A1
(43) Pub. Date: Apr. 9, 2026

(54) Method for Configuring Cooling Tube of Battery Pack and Cooling Tube of Battery Pack

(71) Applicant: LG Energy Solution, Ltd., Seoul (KR)

(72) Inventors: In-Hyuk Jung, Daejeon (KR); Kwang-Keun Oh, Daejeon (KR); Jin-Oh Yang, Daejeon (KR)

(73) Assignee: LG Energy Solution, Ltd., Seoul (KR)

(21) Appl. No.: 19/348,192

(22) Filed: Oct. 2, 2025

(30) Foreign Application Priority Data
Oct. 8, 2024 (KR) 10-2024-0136912

(51) Int. Cl. H01M 10/6568; B60L 50/60; H01M 10/613; H01M 10/625; H01M 10/643; H01M 50/213

(52) U.S. Cl. CPC H01M 10/6568; H01M 10/613; H01M 10/625; H01M 10/643; H01M 50/213; B60L 50/60; H01M 2220/20

(57) ABSTRACT

A method for configuring a cooling tube of a battery pack is disclosed. The method includes providing a cooling tube having a plurality of channels through which a cooling medium flows, and varying a number of channels (N) and an aspect ratio (D) of the channels. A pressure drop (ΔP) and deformation (δ) are determined as functions of N, D, a channel length (L), and a rib thickness (T), and the cooling tube is configured such that ΔP and δ are minimized to improve cooling efficiency. Also disclosed is a cooling tube for a battery pack including a plurality of channels, each having an aspect ratio defined by width and height. The channel arrangement and a rib thickness are selected to reduce pressure loss and channel deformation, thereby maximizing heat transfer efficiency.

### CROSS-REFERENCE TO RELATED APPLICATIONS

This application claims priority to Korean Patent Application No. 10-2024-0136912, filed on Oct. 8, 2024, with the Korean Intellectual Property Office, the disclosure of which is incorporated herein in its entirety by reference.

### BACKGROUND

Secondary batteries, which are used in various products and exhibit superior electrical properties such as high energy density, etc., are commonly used not only in portable devices but also in electric vehicles (EVs) or hybrid electric vehicles (HEVs) driven by electrical power sources. Their adoption is accelerating because they provide substantial environmental and economic benefits: they reduce dependence on fossil fuels, enable greater energy efficiency, and generate no harmful byproducts during operation. In addition, secondary batteries support the transition to sustainable energy systems by facilitating the integration of renewable power and by contributing to reductions in greenhouse gas emissions.

Secondary batteries widely used at the present include lithium ion batteries, lithium polymer batteries, nickel cadmium batteries, nickel hydrogen batteries, nickel zinc batteries and the like. The operating voltage of the unit secondary battery cell, namely a unit battery cell, is about 2.5V to 4.5V. Therefore, if a higher output voltage is required, a plurality of battery cells may be connected in series to configure a battery pack. In addition, depending on the charge/discharge capacity required for the battery pack, a battery pack may be configured by connecting a plurality of battery cells in parallel. Thus, the number of battery cells included in the battery pack may be set according to the required output voltage or the demanded charge/discharge capacity. Consequently, the number of battery cells in the battery pack may be adjusted depending on the desired output voltage and charge/discharge capacity.

When assembling a battery pack, a plurality of individual battery cells are typically connected in series and/or in parallel to achieve the desired voltage and capacity. In practice, the battery pack is formed not only by combining multiple cells but also by incorporating additional structural and functional components, such as bus bars, cooling elements, protective housings, and control circuitry, to ensure stable operation and long-term reliability.

In a conventional battery pack, a cooling tube is provided between battery cells to cool the battery cells. For the cooling tube, it is important to secure heat transfer performance and minimize pressure loss to increase cooling efficiency.

Therefore, there is a need for improved configurations that enhance heat transfer performance while simultaneously minimizing pressure loss.

### BRIEF SUMMARY

The present disclosure is directed to providing a method for configuring a cooling tube of a battery pack, which may secure heat transfer performance and minimize pressure loss, and a cooling tube of a battery pack.

In accordance with the present disclosure, there is provided a method for configuring cooling tubes in battery packs by balancing geometric and functional parameters to achieve optimal performance. The method may involve tailoring the number of channels, the aspect ratio of those channels, and the rib thickness separating them, with pressure drop (ΔP) and deformation (δ) defined as mathematical functions of these variables. By modeling and adjusting these relationships, the present disclosure enables cooling tubes that maintain structural stability during bending to conform to battery cell arrays, while also reducing hydraulic losses and preserving efficient coolant flow. This configuration ensures uniform thermal management across large cell arrays and supports scalability for diverse pack architectures, from compact consumer devices to high-capacity vehicle systems.

The disclosure also encompasses physical embodiments of cooling tubes configured with channel geometries that enhance both mechanical resilience and thermal conductivity. Channels may be formed with elongate, curved profiles to distribute stress, and their numbers are deliberately limited to minimize pressure loss while maximizing heat transfer contact area. Preferred embodiments specify channel sets for coolant inlet and outlet, with defined limits on channel aspect ratios and rib thicknesses to preserve flatness at the cell-contact surface and reduce deformation during pressing or bending. By uniting these structural design features with predictive relationships between flow dynamics and mechanical integrity, the present disclosure delivers a cooling tube that advances battery pack efficiency, reliability, and adaptability across multiple battery cell formats.

In an aspect of the present disclosure, a method for configuring a cooling tube of a battery pack is provided. A method according to this aspect may include the steps of providing a cooling tube with a plurality of channels for a coolant to flow therethrough, the cooling tube defining a length, a width and a height, each channel extending across the length of the cooling tube, varying a number N of channels and an aspect ratio D of each channel in the cooling tube, determining a pressure drop ΔP across the cooling tube for each variation in the number N and aspect ratio D of the channels using an equation ΔP=f (N, D, L, T), where L is the length of the cooling tube and T is a thickness of a rib separating adjacent channels, determining a deformation δ of each channel when the cooling tube is bent to conform to an array of batteries of the battery pack for each variation in the number N and aspect ratio D of channels using an equation δ=f (N, D, T), and determining a relationship between the number of channels N, aspect ratio of the channels D and the thickness of the rib T with reference to the pressure drop ΔP and deformation δ to maximize a cooling efficiency of the cooling tube. The cooling efficiency may be related to minimizing pressure loss and minimizing deformation.

Continuing in accordance with this aspect, the aspect ratio D of each channel may be defined by a height and a width of each channel.

Continuing in accordance with this aspect, each channel may define an elongated shape with curved upper and lower ends. The thickness of each rib T may be the minimum distance between adjacent channels.

Continuing in accordance with this aspect, the step of bending the cooling tube may include bending the cooling tube to conform to a shape of a first linear array of batteries of the battery pack. The cooling tube may contact each of the batteries of the first linear array. The cooling tube may be configured to be placed between the first linear array and a second linear array of batteries of the battery pack, a first side of the cooling tube contacting the first linear array and a second side of the cooling tube contacting the second linear array.

Continuing in accordance with this aspect, the step of determining the pressure drop ΔP may include determining the pressure drop ΔP across the cooling tube for each variation in the number N and aspect ratio D of the channels based on a viscosity and flow rate of the coolant.

Continuing in accordance with this aspect, the step of determining a relationship may include determining a relationship between the number of channels N, aspect ratio D of the channels, pressure drop ΔP, and deformation δ using a correlation analysis.

Continuing in accordance with this aspect, the plurality of channels may include a first set of channels and a second set of channels. The first set of channels may be configured for allowing inlet of the coolant into cooling tube and the second set of channel may be configured for allowing outlet of the coolant from the cooling tube. The cooling tube may be configured to include 5 or less channels for each of the first set of channels and the second set of channels. An aspect ratio of each channel may be 3.45 or less. The thickness of the rib may be 0.34 mm or less. A pressure ΔP per unit length of each channel may be less than 6.67 kPa/m for a coolant flow rate of 1 liter/minute.

In accordance with another aspect of the present disclosure, a cooling tube for a battery pack is provided. A cooling tube according to this embodiment may include a plurality of channels configured to allow coolant to flow through the cooling tube, each channel may have an aspect ratio defined by a height and a width, the cooling tube may be bent to conform to a first linear array of batteries of the battery pack such that a first side surface of the cooling tube contacts the first linear array of batteries. A number of the channels and the aspect ratio of each channel may be configured to maximize cooling efficiency of the cooling tube by minimizing the number of channels to minimize pressure drop caused by the coolant and minimize deformation of the channels caused during bending of the cooling tube.

Continuing in accordance with this aspect, the plurality of channels may include a first set of channels for inlet of the coolant and a second set of channels for outlet of the coolant. The first set of channels may have between 4 and 6 channels and the second set of channels may have between 4 and 6 channels. The first set of channels may have 5 channels and the second set of channels may have 5 channels. The aspect ratio of each of the first and second set of channels may be 4 or less. The aspect ratio of each of the first and second set of channels may be 3.45.

Continuing in accordance with this aspect, a rib may be defined between adjacent channels. A thickness of the rib may be 0.4 mm or less. The thickness may be 0.34 mm. Each channel may define an elongate shape with curved upper and lower ends.

Moreover, various other additional effects may be achieved by various embodiments of the present disclosure. The various effects of the present disclosure will be explained in detail in each embodiment, or the effects that can be easily understood by those skilled in the art will not be described herein.

### BRIEF DESCRIPTION OF THE DRAWINGS

A more complete appreciation of the subject matter of the present disclosure and the various advantages thereof can be realized by reference to the following detailed description, in which reference is made to the following accompanying drawings:

FIG. 1 is a top view of a battery cell array according to an embodiment of the present disclosure.

FIG. 2 is an exploded isometric view of a battery cell array according to an embodiment of the present disclosure.

FIG. 3 is an isometric view of a cooling tube according to an embodiment of the present disclosure.

FIG. 4 is a top view of battery cells and a cooling tube according to an embodiment of the present disclosure.

FIG. 5 is a top view of a cooling tube according to an embodiment of the present disclosure.

FIG. 6 is top view of a cooling tube according to an embodiment of the present disclosure.

FIG. 7 is a top view of a cooling tube according to an embodiment of the present disclosure.

FIG. 8 is a front view of a cooling tube according to an embodiment of the present disclosure.

FIG. 9 is a side cross-sectional view of a cooling tube according to an embodiment of the present disclosure.

FIG. 10 is a schematic view of a manufacturing process of a cooling tube according to an embodiment of the present disclosure.

FIG. 11 is a cross-sectional view of cooling channels after a pressing process according to an embodiment of the present disclosure.

FIG. 12 is graph showing differential pressure per unit length and flow rate according to an embodiment of the present disclosure.

FIG. 13 is graph showing expected differential pressure and flow rate according to an embodiment of the present disclosure.

FIG. 14 is a cross-sectional view of cooling channels of a cooling tube according to an embodiment of the present disclosure.

FIG. 15 is a top view of a battery cell array arrangement of cooling tubes according to an embodiment of the present disclosure.

FIG. 16 is an enlarged view of portion E of FIG. 15.

FIG. 17 is a schematic cross-sectional side view of a battery cell array according to an embodiment of the present disclosure.

FIG. 18 is an enlarged view showing portion F of FIG. 17.

FIG. 19 is a cross-sectional view showing contact between a cooling tube and a battery cell when deformation occurs in the cooling channel of the cooling tube according to an embodiment of the present disclosure.

FIG. 20 is a cross-sectional view showing contact between a cooling tube and a battery cell when deformation occurs in the cooling channel of the cooling tube according to an embodiment of the present disclosure.

FIG. 21 is a cross-sectional view of a battery cell array according to an embodiment of the present disclosure.

FIG. 22 is a cross-sectional view of a battery cell array according to an embodiment of the present disclosure.

FIG. 23 is a schematic view of a battery pack according to an embodiment of the present disclosure.

FIG. 24 is schematic view of a vehicle according to an embodiment of the present disclosure.

### DETAILED DESCRIPTION

Hereinafter, various embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein are examples for the purpose of illustrations only, not intended to limit the scope of the disclosure, so it should be understood that other equivalents and modifications could be made thereto without departing from the scope of the disclosure.

Meanwhile, in this specification, terms indicating directions such as “upper”, “lower”, “left”, “right”, “front”, and “rear” may be used, but these terms are only for convenience of explanation, and it is obvious to those skilled in the art these terms may vary depending on the location of a target object or the location of an observer.

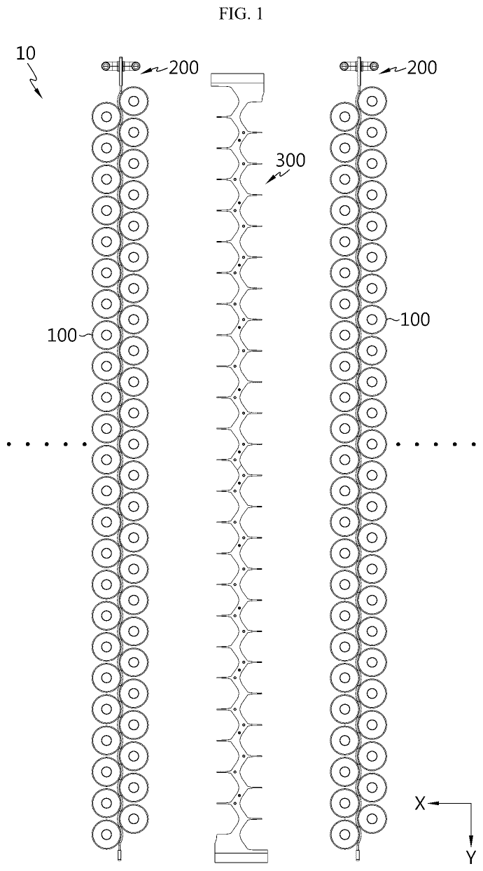

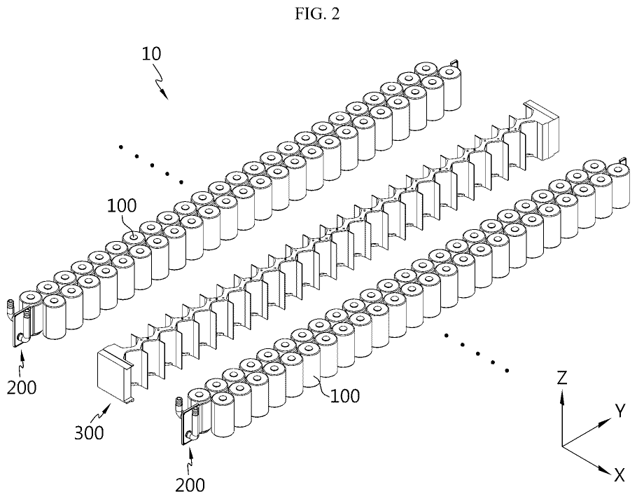

FIG. 1 is a schematic view for illustrating a battery cell array according to an embodiment of the present disclosure. FIG. 2 is a schematic exploded perspective view for illustrating a battery cell array according to an embodiment of the present disclosure.

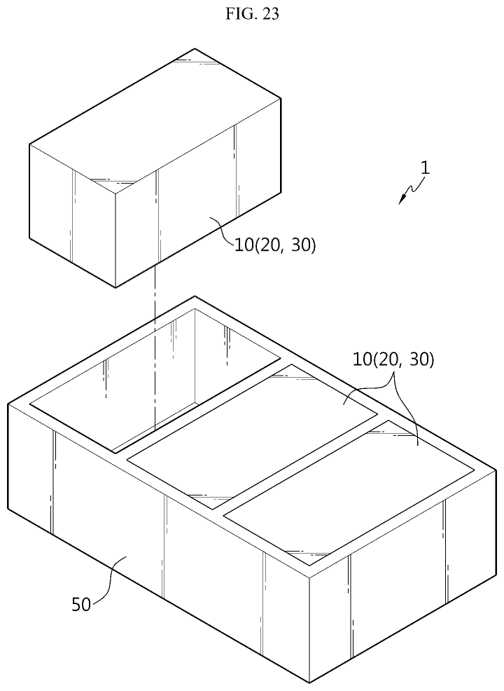

Referring to FIGS. 1 and 2, the battery cell array 10 may include battery cells 100 and a cooling tube 200. The battery cell array 10 may be a component of a battery pack 1 (see FIG. 23) described below. That is, the battery pack 1 (see FIG. 23) described below may include the battery cell array 10.

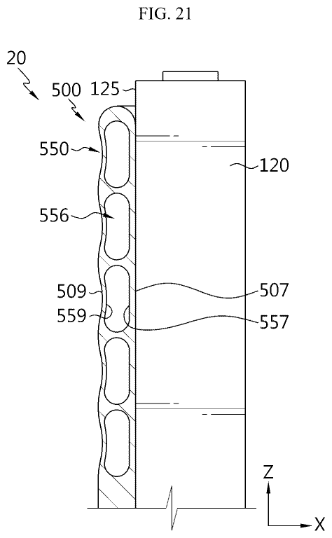

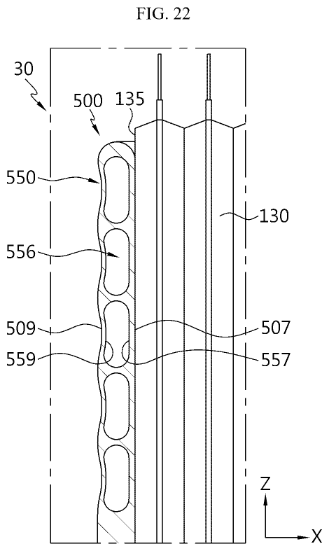

The battery cells 100 may be provided in plurality. The plurality of battery cells 100 are secondary batteries, and may be provided as cylindrical secondary batteries, square secondary batteries, or pouch-type secondary batteries. First, in this embodiment, the battery cells 100 are described as being cylindrical secondary batteries, and the case where the battery cells 102 (see FIG. 21) are provided as square secondary batteries or the battery cells 103 (see FIG. 22) are provided as pouch-type secondary batteries will be described in more detail later with reference to the related drawings.

The cooling tube 200 is positioned between adjacent battery cells 100 and may be secured in direct contact with the cells to enhance heat dissipation efficiency. To facilitate this arrangement, the cooling tube 200 includes a designated cell-attachment surface formed on its outer surface, which is configured to engage with and transfer heat away from the plurality of battery cells 100.

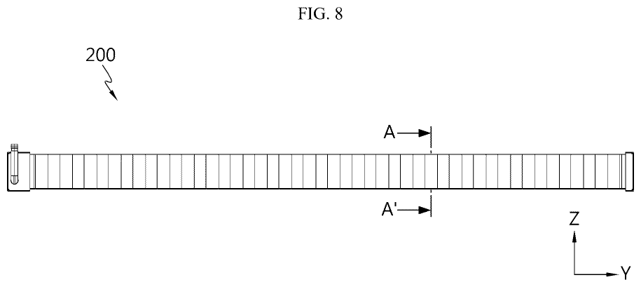

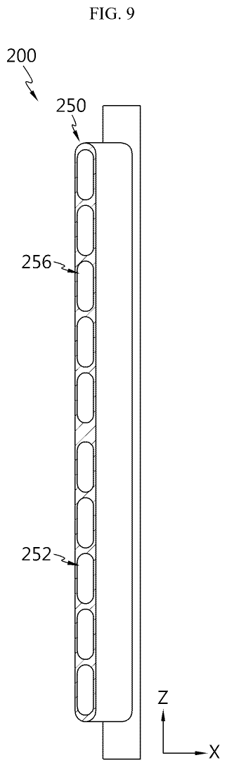

The cooling tube 200 can include at least one cooling channel 250 (see FIG. 9) through which a cooling medium flows. In one embodiment, the cooling medium is a liquid, such as water, which provides high thermal conductivity and circulation efficiency. However, the present disclosure is not limited to water; other fluids capable of effective heat exchange with the surrounding environment may also be employed, including aqueous solutions, dielectric coolants, or other specialized thermal management fluids. To enhance thermal transfer from the battery cells 100, the cell-attachment surface corresponding to the cooling channel 250 (see FIG. 9) may be formed as a flat surface, thereby maximizing the contact area with the battery cells and promoting more efficient heat dissipation.

The cooling tube 200 may be formed with a curvature along its longitudinal direction (Y-axis) to enhance thermal contact when used with cylindrical battery cells 100. This curvature allows the tube to conform more closely to the outer surface 105 of the cylindrical cells, thereby increasing the effective contact area and improving cooling performance. However, during manufacturing processes such as pressing, the cooling channel 250 within the tube may experience deformation, resulting in bending or warping of the cell-attachment surface. When such deformation reduces the flatness of the attachment surface, the adhesion between the cooling tube 200 and the cylindrical battery cells 100 can be diminished. This reduction in contact leads to a smaller effective heat transfer area and, consequently, a decline in the overall heat dissipation performance of the cooling tube.

The curved shape due to deformation of the cooling channel 250 may be caused during the pressing process for forming the curvature of the cooling tube 200, explained later.

In one embodiment of the present disclosure, the cell attachment surface of the cooling tube 200 is maintained as a substantially flat surface even after the pressing process. This configuration reduces the likelihood of deformation at the attachment surface and minimizes variations in heat transfer performance within the cooling channel 250 near that surface. As a result, the adhesion between the cooling tube 200 and the battery cells 100 is enhanced, the effective heat transfer area is maximized, and the risk of reduced cooling efficiency is substantially mitigated.

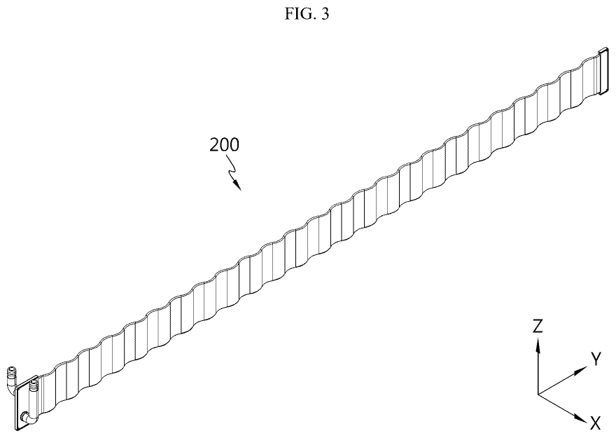

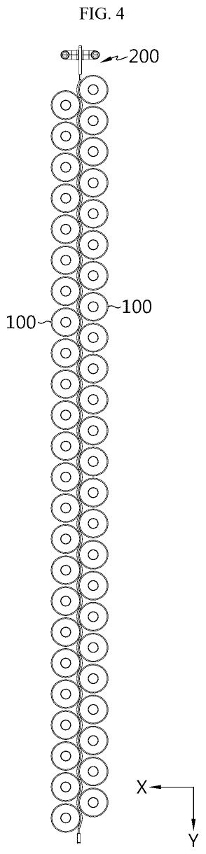

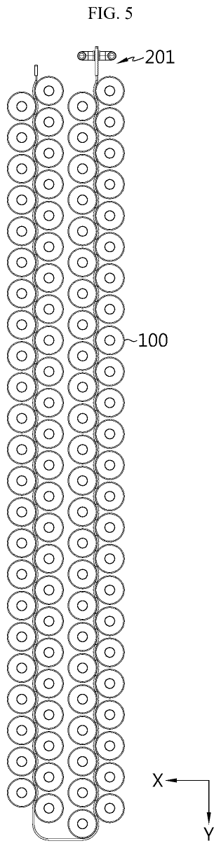

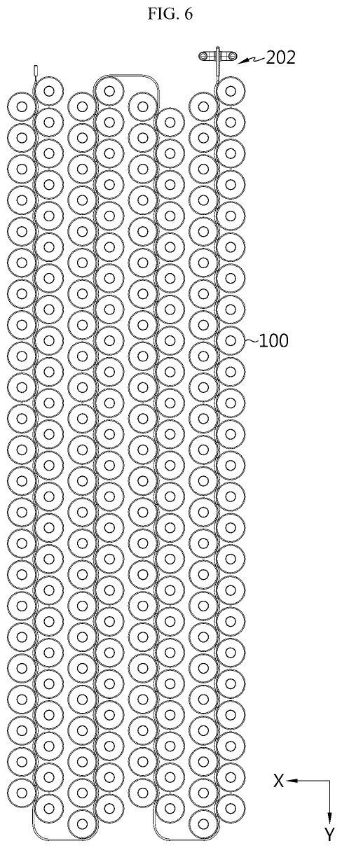

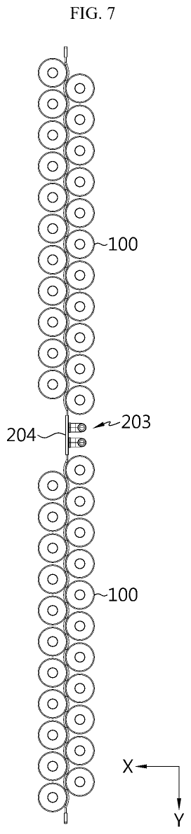

FIG. 3 is a drawing for illustrating a cooling tube according to an embodiment of the present disclosure. FIG. 4 is a plan view showing battery cells and a cooling tube according to an embodiment of the present disclosure. FIG. 5 is a drawing for illustrating a cooling tube according to another embodiment of the present disclosure. FIG. 6 is a drawing for illustrating a cooling tube according to still another embodiment of the present disclosure. FIG. 7 is a drawing for illustrating a cooling tube according to still another embodiment of the present disclosure.

Referring to FIGS. 3 and 4, the cooling tube 200 may be fabricated from a material having high thermal conductivity to promote efficient heat transfer from the battery cells. For example, the cooling tube 200 may be formed of aluminum, which offers excellent thermal conductivity, low weight, and good formability for manufacturing. Other thermally conductive materials, such as copper or aluminum alloys, may also be used in certain embodiments depending on performance and cost considerations.

The cooling tube 200 may be formed with a predetermined length and may have a curvature shape in the length direction (Y-axis direction). The curvature shape may be formed by alternating convex portions and concave portions in the length direction (Y-axis direction). The alternating arrangement of the convex portions and the concave portions may mean that one concave portion is arranged between two convex portions, and one convex portion is arranged between two concave portions. The plurality of battery cells 100 may be arranged in two rows with the cooling tube 200 interposed therebetween in the length direction, and may be arranged to be attached to the convex portions and the concave portions. Here, the two rows of battery cells 100 may be configured as a first linear array and a second linear array, each of which includes a plurality of the battery cells 100. The first surface of the cooling tube 200 may be in contact with the first linear array, and the second surface of the cooling tube 200 may be in contact with the second linear array.

Referring to FIG. 5, the cooling tube 201 may have a shape and structure that accommodates the battery cells 100 arranged in at least four rows. Specifically, the cooling tube 201 may be formed to have a length at least twice that of the cooling tube 200 described above, and may have a curvature shape in the length direction (Y-axis direction). The curvature shape may be formed by alternating convex portions and concave portions in the length direction (Y-axis direction). The cooling tube 201 may be formed to extend by a predetermined length to one side (+Y-axis direction) in the length direction (Y-axis direction), and to be bent at least once at one end (+Y-axis direction) along the length direction (Y-axis direction) and to extend by a predetermined length in the opposite direction (−Y-axis direction). In this way, the cooling tube 201 according to this embodiment may be formed to be attached to a total of four rows of battery cells 100 by dividing the four rows of battery cells 100 into two sets, each including two rows of battery cells 100. In addition, the cooling tube 201 has a cooling channel 250 (see FIG. 9) similar to the cooling tube 200 described above.

Referring to FIG. 6, the cooling tube 202 may have a multi-bent structure with a predetermined length, and may have a curvature shape in the length direction (Y-axis direction). The curvature shape may be formed by alternating convex portions and concave portions in the length direction (Y-axis direction). Specifically, the cooling tube 202 may be formed as a winding snake-like structure capable of covering a plurality of battery cells 100 in four or more rows through the multi-bent structure that is bent two or more times. Through the cooling tube 202 having such a multi-bent structure, it is possible to implement integrated cooling of multiple rows of battery cells 100, thereby reducing the number of cooling tubes 202. Through the cooling tube 202 having such a multi-bent structure, it may also be possible to cool multiple rows of battery cells 100 with one cooling tube 202, depending on the design. Meanwhile, the cooling tube 202 also has a cooling channel 250 (see FIG. 9) similar to the cooling tube 200.

Referring to FIG. 7, the cooling tube 203 may be formed to extend from the cooling medium inlet/outlet portion 204, which is connected to an external cooling line, etc., by a predetermined length to both sides (+Y-axis direction and −Y-axis direction) in the length direction (Y-axis direction). The cooling tube 203 is formed to a predetermined length in each direction (+Y-axis direction and −Y-axis direction) and may have a curvature shape in the length direction (Y-axis direction). The curvature shape may be formed by alternating convex portions and concave portions in the length direction (Y-axis direction).

In this way, the cooling tube 203 may have a bidirectional cooling structure in which the cooling medium inlet/outlet portion 204 is positioned at the center and extends to both sides (+Y-axis direction and −Y-axis direction) in the length direction (Y-axis direction).

Moreover, the cooling tube 203 also has a cooling channel 250 (see FIG. 9) similar to the cooling tube 200.

In this embodiment, in all of the cooling tubes 200, 201, 202, 203 of various structures, the cell attachment surface may be secured as a flat surface according to the design structure described below, thereby reducing the risk of deformation of the cell attachment surface of the cooling tubes 200, 201, 202, 203 and significantly reducing the risk of heat transfer deviation occurring inside the cooling channel 250 near the cell attachment surface.

Therefore, in an embodiment of the present disclosure, the heat transfer area may be secured to the maximum while increasing the close contact between the cooling tubes 200, 201, 202, 203 and the battery cells 100, thereby preventing a decrease in the heat transfer performance of the cooling tube 200.

Hereinafter, the shape of the cooling channel 250 according to an embodiment of the present disclosure will be described in more detail, focusing on the cooling tube 200 representatively among the cooling tubes 200, 201, 202, 203. Although the description below is limited to the cooling tube 200, it is also applicable to the cooling tubes 201, 202, 203.

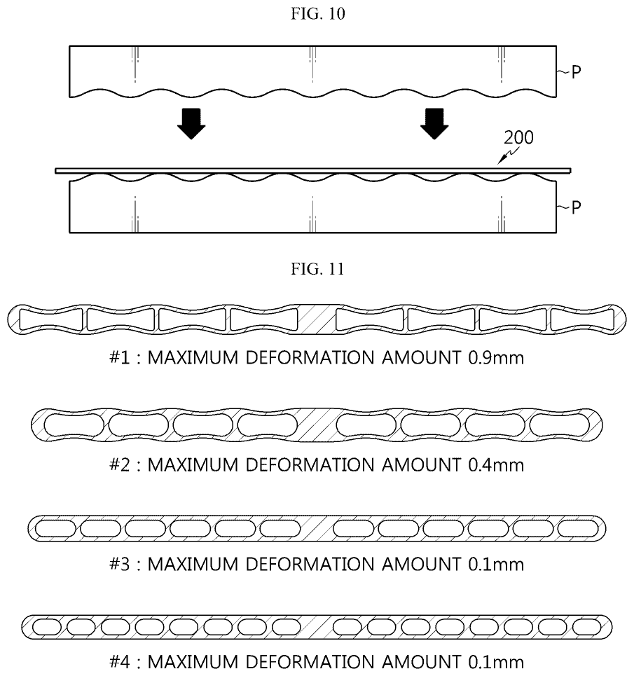

FIG. 8 is a front view showing a cooling tube according to an embodiment of the present disclosure. FIG. 9 is a side cross-sectional view showing a cooling tube according to an embodiment of the present disclosure. FIG. 10 is a drawing for illustrating a manufacturing process of a cooling tube according to an embodiment of the present disclosure through a pressing process.

Referring to FIGS. 8-10 and the preceding drawings, the cooling tube 200 may be formed into the curvature shape by applying pressure using a press device P when manufacturing the cooling tube 200. That is, the cooling tube 200 may be manufactured so that the convex portion and the concave portion are alternately provided by pressing of the press device P. In other words, the cooling tube 200 may be bent by pressing of the press device P. Here, the cooling tube 200 may be bent to fit the shape of at least one of the first linear array and the second linear array of the battery cells 100.

The cooling channel 250 may be provided in a preset plural number that does not cause deformation of the cooling channel 250 when pressurized. The number of cooling channels 250 is an important design factor related to deformation of the cooling channel 250 when pressurized. In the cooling tube 200, as the number of cooling channels 250 increases, deformation of the cooling channel 250 when pressurized may be reduced. However, there is a problem that as the number of cooling channels 250 increases, the pressure loss of the cooling tube 200 also increases. If the pressure loss of the cooling tube 200 is large, the output of the pump for circulating the cooling medium toward the cooling channel 250 must be increased, which increases power consumption and lowers the overall efficiency of the battery cell array 10.

Therefore, in the cooling tube 200, it is important that the number of cooling channels 250 is set to a preset number that reduces the pressure loss and does not cause deformation of the cooling channels 250 during the pressing process. In an embodiment of the present disclosure, the cooling channels 250 are provided in 10 units, and ten cooling channels 250 may be arranged at a predetermined distance from each other along the height direction of the cooling tube 200.

The cooling channels 250 may include an inlet channel 252 and an outlet channel 256.

The inlet channel 252 may guide the cooling medium supplied from an external cooling device toward the cooling tube 200. The inlet channel 252 may be arranged in a lower portion with respect to the central axis of the cooling tube 200 in the height direction (Z-axis direction) of the cooling tube 200. The inlet channel 252 is formed long along the length direction (Y-axis direction) of the cooling tube 200, and may cause the cooling medium to flow along the length direction (Y-axis direction) in the lower portion of the cooling tube 200.

The inlet channel 252 may be provided in a preset number. In this embodiment, the inlet channel 252 may be provided in plurality, and specifically, five inlet channels 252 may be provided. The number of inlet channels 252 may be selected by considering both aspects of reducing pressure loss and not causing deformation during the pressing process as described above. The plurality of inlet channels 252 may be arranged to be spaced apart from each other by a predetermined distance along the height direction (Z-axis direction) of the cooling tube 200.

The plurality of inlet channels 252 may be the first channel set that allows the introduction of the cooling medium into the cooling tube 200.

The outlet channel 256 is communicated with the inlet channel 252 and may guide the cooling medium flowing in the inlet channel 252 to the external cooling device. The outlet channel 256 may be arranged in an upper portion based on the central axis of the cooling tube 200 in the height direction (Z-axis direction) of the cooling tube 200. Specifically, the outlet channel 256 may be provided at the upper side of the inlet channel 252 in the height direction (Z-axis direction) of the cooling tube 200. The outlet channel 256 is formed long along the length direction (Y-axis direction) of the cooling tube 200 and may allow the cooling medium to flow along the length direction (Y-axis direction) in the upper portion of the cooling tube 200.

The outlet channel 256 may be provided in a preset number. In this embodiment, the outlet channel 256 may be provided in plurality, and specifically, in five outlet channels 256 may be provided. The number of outlet channels 256 may be selected by considering both aspects of reducing pressure loss and not causing deformation during the pressing process described above. The plurality of outlet channels 256 may be spaced apart from each other by a predetermined distance along the height direction (Z-axis direction) of the cooling tube 200. Consequently, the inlet channels 252 and the outlet channels 256 may respectively arranged to be spaced apart from each other by a predetermined interval in the height direction (Z-axis direction) of the cooling tube 200.

The plurality of outlet channels 256 may be the second channel set that allows the cooling medium to flow out from the cooling tube 200.

Meanwhile, the cooling medium may enter the inlet channel 252 through a port connected to the external cooling device of the cooling tube 200, flow along the length direction of the inlet channel 252, then move to the outlet channel 256 at the opposite side of the port, flow along the length direction of the outlet channel 256, and then move back to the external cooling device through the port. This flow path of the cooling medium may be roughly U-shaped.

Hereinafter, the test results related to the deformation of the cooling channel 250 during the pressing process associated with the number of cooling channels 250 of the cooling tube 200 will be described.

FIG. 11 is a drawing for illustrating a cross-sectional appearance of a cooling channel after a pressing process according to the number of cooling channels in a cooling tube according to an embodiment of the present disclosure.

Referring to FIG. 11 and the former drawings, it may be found that as the number of cooling channels 250 increases in the cooling tube 200 from case 1 to case 4, the maximum deformation amount of the cooling channel 250 decreases. Specifically, as in cases 1 and 2, when the number of cooling channels 250 is 8 in total (specifically, 4 inlet channels and 4 outlet channels, respectively), it may be found that the maximum deformation amount of the cooling channel 250 is greater than in cases 3 and 4 where the number of cooling channels 250 is larger than in cases 1 and 2. Meanwhile, comparing case 1 and case 2, it may be found that even when the number of cooling channels 250 is the same, a difference occurs in the maximum deformation amount depending on the interval between the cooling channels 250.

Comparing case 3 and case 4, it may be found that the maximum deformation amount of the cooling channels 250 of case 3 (12 cooling channels including 6 inlet channels and 6 outlet channels, respectively) and case 4 (16 cooling channels including 8 inlet channels and 8 outlet channels, respectively) are the same. In this case, it may be preferable to configure the cooling channels like case 3 rather than case 4 to reduce pressure loss. In this way, the number of cooling channels 250 may be set to a preset number that does not cause deformation while reducing pressure loss.

In the cooling channel 250 according to an embodiment of the present disclosure, considering the above, as described above, a total of 10 channels may be provided, including 5 inlet channels 252 and 5 outlet channels 256, respectively.

Meanwhile, with regard to the deformation of the cooling channel, the pressing speed during the pressing process does not have a significant effect, even at different speeds. In other words, with regard to the flatness of the cell attachment surface of the cooling channel, the pressing speed during the pressing process had a small effect on the flatness.

These results highlight the importance of optimizing the number and arrangement of cooling channels to improve battery performance. Increasing the number of cooling channels distributes the cooling load more evenly, thereby reducing the maximum deformation that may occur during the pressing process. This not only improves the structural integrity of the cooling channels but also enhances the overall thermal management of the battery pack, which is essential for maintaining optimal operating temperatures and extending battery life.

In addition, the minimal effect of pressing speed on the flatness of the cooling channels suggests that manufacturers may focus on other variables, such as material properties and channel design, to minimize deformation. This may lead to the development of more robust cooling systems that are less sensitive to manufacturing process variations, thereby further improving the reliability and consistency of battery pack production. For example, when ten cooling channels including five inlet channels and five outlet channels, respectively, is provided, it is possible to provide an approach to a balanced cooling channel design that maximizes cooling efficiency while minimizing pressure loss and deformation. This configuration may be adjusted to specific applications, ensuring that each battery pack meets the unique performance requirements of various devices ranging from consumer home appliances to high-demand electric vehicles.

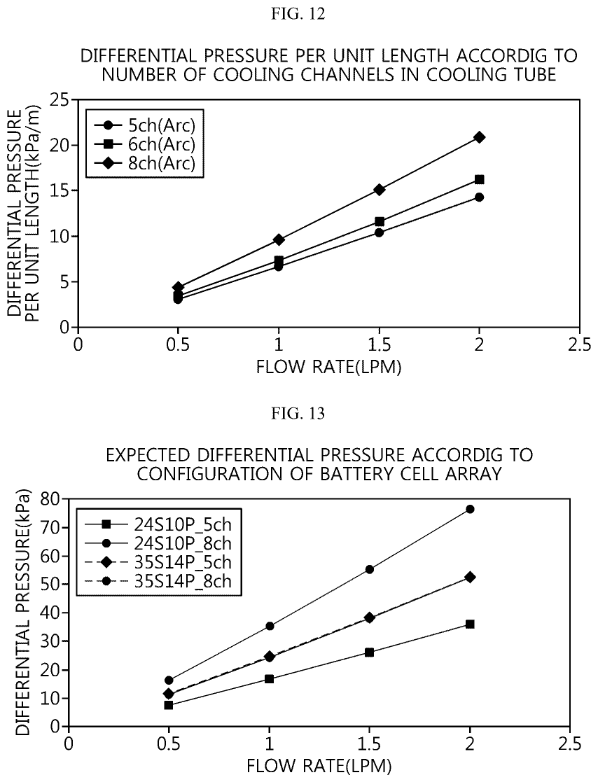

FIG. 12 is a drawing for illustrating a differential pressure per unit length according to the number of cooling channels in a cooling tube according to an embodiment of the present disclosure, and Table 1 below is a table showing the differential pressure for the flow rate for the number of cooling channels of the cooling tube according to an embodiment of the present disclosure.

TABLE 1

| | Differential | | | | |
|---|---|---|---|---|---|
| | pressure per | | | | |
| | unit length | 0.5 | 1 | 1.5 | 2 |
| Differential | 5ch (Arc) | 3.1 | 6.67 | 10.40 | 14.28 |
| pressure per unit | 6ch (Arc) | 3.41 | 7.38 | 11.59 | 16.19 |
| length (kPa/m) | 8ch (Arc) | 4.44 | 9.60 | 15.08 | 20.87 |

Referring to FIG. 12 and Table 1, the differential pressure results per unit length according to the number of cooling tube channels are shown. It may be found that the differential pressure per unit length increases as the flow rate increases, and the differential pressure also increases as the number of cooling channels increases. The test results show that when the cooling channel is configured with 8 channels, the pressure loss increases by approximately 45% compared to when the cooling channel is configured with 5 channels.

Meanwhile, the number of channels in the test of 5 channels, 6 channels, and 8 channels may refer to the number of inlet channels and outlet channels, respectively, rather than the total number of cooling channels. That is, in the case of 5 channels, it may mean that the cooling tube is configured with 5 inlet channels and 5 outlet channels, namely a total of 10 cooling channels. Similarly, in the case of 8 channels, it may mean that the cooling channels are configured with a total of 16 cooling channels. Ultimately, the test results show that the pressure loss may be reduced by decreasing the number of cooling channels in the cooling tube.

Therefore, the test data shows that the differential pressure increases as the flow rate and number of cooling channels increase. In particular, the pressure loss is approximately 45% higher in 8 channels compared to 5 channels. The test results indicate that the number of channels refers to both the number of inlet and outlet channels, which means that 5 channels correspond to a total of 10 cooling channels. If the number of cooling channels is decreased, the pressure loss may be effectively reduced, thereby increasing the energy-efficient cooling medium flow. While more channels may improve heat dissipation, it is important to manage the channels to avoid excessive pressure loss, which is critical in applications such as electric vehicles and hybrid electric vehicles.

These test results highlight the importance of balancing the number and design of cooling channels in order to contribute to the development of better cooling solutions for high-performance battery packs.

FIG. 13 is a drawing for illustrating an expected differential pressure according to the configuration of a battery cell array according to an embodiment of the present disclosure, and Table 2 below shows the expected differential pressure according to the configuration of the battery cell array according to an embodiment of the present disclosure.

TABLE 2

| | Flow rate (LPM) | 0.5 | 1 | 1.5 | 2 |
|---|---|---|---|---|---|
| Differential | 24S10P_5ch | 7.8 | 16.8 | 26.2 | 36 |
| pressure | 24S10P_8ch | 11.2 | 24.2 | 38 | 52.6 |
| (kPa) | 35S14P_5ch | 11.3 | 24.4 | 38.1 | 52.3 |
| | 35S14P_8ch | 16.3 | 35.2 | 55.2 | 76.5 |

Referring to FIG. 13 and Table 2, the expected differential pressure results according to the battery cell array configuration are shown. It may be found that the differential pressure increases as the flow rate increases, and it may be found that the differential pressure increases as the number of battery cells increases. Meanwhile, in FIGS. 9 and 10, only the flow path length of the cooling channel in the cooling tube is reflected, and the port and the end plate portion connected to the external cooling device are not reflected. Accordingly, for example, in the case of a 24S10P array, the flow path length may be approximately 2520.4 mm (=2*1260.2 mm), and in the case of a 35S14P array, the flow path length may be approximately 3663.3 mm (=2*1831.7 mm).

The test results show that the differential pressure of the 8-channel configuration of the 24S10P array and the 5-channel configuration of the 35S14P array are almost the same. In other words, when the cooling channels of the cooling tube are configured as 5 channels (5 inlet channels and 5 outlet channels, a total of 10 channels), more battery cells may be attached to the cooling tube. In other words, the cooling tube may be made longer, approximately 45% longer.

In this way, when the number of cooling channels of the cooling tube is configured as 5 channels for inlet channels and outlet channels, respectively, a cooling tube that may relatively freely configure the battery cell array while allowing more battery cells to be attached may be designed.

Therefore, FIG. 13 and Table 2 show that the differential pressure increases according to the flow rate and the number of battery cells. For example, the length of the cooling channel of the 24S10P array is approximately 2520.4 mm, while the length of the cooling channel of the 35S14P array is approximately 3663.3 mm. Although the length of the 35S14P array is longer, the differential pressure is similar between the 8-channel configuration of the 24S10P array and the 5-channel configuration of the 35S14P array. This indicates that the 5-channel configuration (5 inlet channels and 5 outlet channels, a total of 10 channels) allows for more battery cells and longer cooling tubes to be used approximately 45% longer. This design not only accommodates more battery cells but also provides flexibility in battery cell array configuration, which may improve thermal management and overall performance.

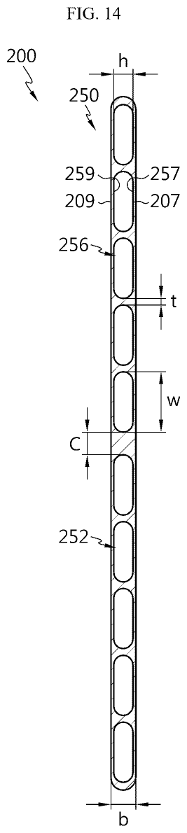

FIG. 14 is a schematic drawing for illustrating the cooling channels of a cooling tube according to an embodiment of the present disclosure, Table 3 below is a table for explaining the number of channels and the shape information of the cooling channel of the cooling tube of FIG. 14, Table 4 below is a table for explaining the simulation results according to the number of channels and the shape of the cooling channel according to an embodiment of the present disclosure, and Table 5 below is a table for explaining the influence analysis according to the simulation results of Table 4.

TABLE 3

| Dimension item | t | w | h | Number | Shape |
|---|---|---|---|---|---|
| | 0.34 | 6.08 | 1.76 | 5 | round |

TABLE 4

| | | | | Differential | |
|---|---|---|---|---|---|
| | | | | pressure | Deformation |
| No. | t | w | h | (kPa) | amount |
| 1 | 0.34 | 6.08 | 1.8 | 5.71 | 0.409 |
| 2 | 0.34 | 6.08 | 1.78 | 5.89 | 0.391 |
| 3 | 0.34 | 6.08 | 1.76 | 6.08 | 0.374 |
| 4 | 0.39 | 6.04 | 1.8 | 5.76 | 0.422 |
| 5 | 0.39 | 6.04 | 1.78 | 5.94 | 0.405 |
| 6 | 0.39 | 6.04 | 1.76 | 6.12 | 0.388 |
| 7 | 0.44 | 6 | 1.8 | 5.8 | 0.429 |
| 8 | 0.44 | 6 | 1.78 | 5.98 | 0.413 |
| 9 | 0.44 | 6 | 1.76 | 6.17 | 0.397 |
| 10 | 0.49 | 5.96 | 1.8 | 5.85 | 0.434 |
| 11 | 0.49 | 5.96 | 1.78 | 6.03 | 0.418 |
| 12 | 0.49 | 5.96 | 1.76 | 6.23 | 0.401 |
| 13 | 0.54 | 5.92 | 1.8 | 5.9 | 0.436 |
| 14 | 0.54 | 5.92 | 1.78 | 6.09 | 0.421 |
| 15 | 0.59 | 5.88 | 1.8 | 5.95 | 0.437 |
| 16 | 0.59 | 5.88 | 1.78 | 6.14 | 0.422 |
| 17 | 0.64 | 5.84 | 1.8 | 6 | 0.437 |
| 18 | 0.64 | 5.84 | 1.78 | 6.19 | 0.421 |
| 19 | 0.69 | 5.8 | 1.8 | 6.06 | 0.435 |
| 20 | 0.69 | 5.8 | 1.78 | 6.24 | 0.419 |
| 21 | 0.74 | 5.76 | 1.8 | 6.11 | 0.433 |
| 22 | 0.79 | 5.72 | 1.8 | 6.16 | 0.430 |
| 23 | 0.84 | 5.68 | 1.8 | 6.22 | 0.426 |

TABLE 5

| | | | | Differential | |
|---|---|---|---|---|---|
| | | | | pressure | Deformation |
| | t | w | h | (kPa) | amount |
| t | 1.000 | | | | |
| w | −1.000 | 1.000 | | | |
| h | 0.438 | −0.438 | 1.000 | | |
| Differential | 0.573 | −0.573 | −0.485 | 1.000 | |
| pressure (kPa) | | | | | |
| Deformation | 0.658 | −0.658 | 0.836 | −0.134 | 1.000 |
| amount | | | | | |

Referring to FIG. 14 and Tables 3 to 5, as described above, it is important that deformation of the cell attachment surface 207 of the cooling channel 250 of the cooling tube 200 does not occur during the aforementioned pressing process of the cooling tube 200. It is important to prevent deformation of the cell attachment surface 207 of the cooling tube 200 because it reduces the contact area of the cell attachment surface 207 with the battery cells 100 and thus reduces the heat transfer area and lowers the overall cooling performance. Therefore, it is important to design the cell attachment surface 207 of the cooling tube 200 as a flat surface without deformation even during the pressing process.

During the pressing process (see FIG. 10), the cell attachment surface 207 is pressed concavely and is relatively compressed, so that deformation is small, and the cell non-attachment surface 209 is pressed convexly during the pressing process and is relatively elongated compared to the cell attachment surface 207, so that deformation may occur more. According to the concave and convex shapes, during the pressing process, deformation of the cooling channel 250 provided in a hollow shape within the cooling tube 200 between the cell attachment surface 207 and the cell non-attachment surface 209 is highly likely to occur. Since the cooling channel 250 is provided in a hollow shape for an internal flow path within the cooling tube 200, deformation of the cooling channel 250 in a hollow shape is highly likely to occur during the pressing process.

When the cooling channel 250 is deformed, the outer surfaces 207, 209 of the cooling tube 200, which are outer sides of the cooling channel 250, may also be deformed. For example, when deformation occurs, such as when the cooling channel 250 is depressed to a predetermined depth, the outer surfaces 207, 209 of the cooling tube 200, namely the cell attachment surface 207 and the cell non-attachment surface 209 of the cooling tube 200, may also be depressed to a predetermined depth by an amount equal to the deformation amount of the cooling channel 250. Conversely, during the pressing process, deformation may occur on the inner surfaces 257, 259 of the cooling tube 200 due to deformation of the cell attachment surface 207 and the cell non-attachment surface 209.

Here, in particular, deformation of the cell attachment surface 207 reduces the contact area with the battery cells 100, which may lower heat transfer performance and function as a factor in lowering cooling performance.

Meanwhile, relatively, the opposite surface 209 of the cell attachment surface 207 of the cooling tube 200 in the cooling channel 250 is unrelated to the heat transfer performance, so it is relatively unimportant whether the opposite surface 209 of the cell attachment surface 207 of the cooling tube 200 undergoes deformation.

Therefore, it is necessary to design a cooling channel 250 that may minimize deformation of the cell attachment surface 207 in the cooling tube 200 while also reducing pressure loss.

First, as described above, a total of 10 cooling channels 250 may be provided, including 5 inlet channels 252 and 5 outlet channels 256. In an embodiment of the present disclosure, the thickness (b) of the cooling tube 200 may be 2.5 mm. In addition, the interval (c) between the inlet channel 252 and the outlet channel 256, which are arranged closest to each other in the height direction of the cooling tube 200, may be 4 mm. In the simulation, the thickness (b) of the cooling tube 200 and the interval (c) between the inlet channel 252 and the outlet channel 256, which are arranged closest to each other, may be fixed dimensions. Meanwhile, the compression distance through the pressing process may be 6.44 mm (initially 2.50 mm), and the preset differential pressure allowable range may be approximately 6.25 kPa.

The dimension item t may refer to a predetermined interval between the cooling channels 250 in the height direction of the cooling tube 200. Specifically, the dimension item t may refer to a predetermined interval between the inlet channels 252 spaced apart from each other and a predetermined interval between the outlet channels 256 spaced apart from each other in the height direction of the cooling tube 200. The dimension item w may refer to a length in the height direction of the cooling tube 200. Specifically, it may refer to a length (w) of each inlet channel 252 and each outlet channel 256 in the height direction of the cooling tube 200. The dimension item h may refer to a width of the cooling channel 250 in the thickness (b) direction of the cooling tube 200. Specifically, it may refer to a width (h) of the cooling channel 250 in the stacking direction (X-axis direction) of the battery cells 100 (see FIG. 1).

Referring to Table 4, it may be found that as the dimension item h (the width of the cooling channel 250 in the thickness (b) direction of the cooling tube 200) becomes smaller, the deformation amount becomes smaller. For example, as shown in No. 1 to No. 3, it may be found that as the dimension item h becomes smaller to 1.8 mm, 1.78 mm, and 1.76 mm, the deformation amount also becomes smaller to 0.409, 0.391, and 0.374, in that order. In addition, as shown in No. 4 to No. 6, it may be found that as the dimension item h becomes smaller to 1.8 mm, 1.78 mm, and 1.76 mm, the deformation amount also becomes smaller to 0.422, 0.405, and 0.388, in that order. As the dimension item t (a predetermined interval between the inlet channels 252 and between the outlet channels 256 spaced apart from each other in the height direction of the cooling tube 200) increases, the deformation amount increases. In addition, as the dimension item w (the length of each inlet channel 252 and each outlet channel 256 in the height direction of the cooling tube 200) decreases, the deformation amount increases. In summary, it may be found that the result with the smallest deformation amount within the differential pressure allowable range (6.25 kPa) is case 3 of the simulation result according to No. 3.

Referring to Table 5, the influence according to these dimension items is analyzed as follows. First, in the table, as being closer to 1, it means that the influence between the two factors is high. It may be found that the absolute values of the differences between the positive and negative values of the dimension item t (a predetermined interval between the cooling channels 250 in the height direction of the cooling tube 200) and the dimension item w (a length of each inlet channel 252 and each outlet channel 256 in the height direction of the cooling tube 200) are the same. This may mean that the absolute values of the influences are the same. As shown in the table, the factors that mainly have a large influence on the difference in deformation amount are the dimension item t (a predetermined interval between the cooling channels 250 in the height direction of the cooling tube 200) and the dimension item h, and it may be found that the dimension item h has a relatively higher influence than the dimension item t.

In this way, the cooling channel 250 may preferably have a length (w) of 5.6 mm to 6.1 mm in the height direction of the cooling tube 200. Specifically, in the height direction of the cooling tube 200, each cooling tube 200 may have a length of 6.08 mm in the height direction of the cooling tube. More specifically, in the height direction of the cooling tube 200, the length (w) of each inlet channel 252 and each outlet channel 256 may be 6.08 mm.

In addition, the predetermined interval (t) between the cooling channels 250 in the height direction of the cooling tube 200 may be 0.3 mm to 0.9 mm. Specifically, the predetermined interval (t) may be 0.34 mm in the height direction of the cooling tube 200. More specifically, the predetermined interval (t) between the inlet channels 252 and the predetermined interval (t) between the outlet channels 256 in the height direction of the cooling tube 200 may be 0.34 mm.

Meanwhile, a rib may be defined between adjacent channels in the cooling channels 250. For example, the thickness of the rib may be 0.4 mm or less. Preferably, the thickness may be 0.34 mm. That is, the rib may be a portion corresponding to the predetermined interval (t) between the cooling channels 250, and the thickness of each rib may be the minimum distance between adjacent channels.

The width (h) of the cooling channel 250 in the thickness (b) direction of the cooling tube 200 may be 1.7 mm to 1.8 mm. Specifically, the width (h) of the cooling channel 250 may be 1.7 mm to 1.8 mm in the stacking direction (X-axis direction) of the battery cells 100 (see FIG. 1). More specifically, the width (h) of the cooling channel 250 may be 1.76 mm in the stacking direction of the battery cells 100.

In addition, the cooling channel 250 may have a round-shaped end in the height direction of the cooling tube 200. The cooling channel 250 may be defined as an elongated shape with curved top and bottom ends.

As described above, the cooling channels 250 according to an embodiment of the present disclosure as shown in Table 3 may be formed to have a round end in the height direction of the cooling tube 200, to have an interval (t) of 0.34 mm therebetween in the height direction of the cooling tube 200, to have a length (w) of 6.08 mm in the height direction of the cooling tube 200, and to have a thickness (h) of 1.76 mm in the thickness direction (b).

In one embodiment of the present disclosure, it is possible to provide a cooling tube 200 that minimizes deformation of the cell attachment surface and the cooling channel near the cell attachment surface while also significantly reducing pressure loss through cooling channels 250 provided with the above shape, size, and number.

Therefore, in an embodiment of the present disclosure, the energy consumption for cooling the battery cells 100 may be reduced through the cooling tube 200 that may secure heat transfer performance while minimizing the pressure loss, resulting in more efficient operation of the entire system.

Referring again to FIGS. 1 and 2, the battery cell array 10 may include a side structure unit 300.

The side structure unit 300 supports the battery cells 100 and may secure the rigidity of the battery cells 100. The side structure unit 300 is formed to have a predetermined length along the length direction of the battery cell array 10, and is provided in plurality, and the plurality of side structure units 300 may be assembled with each other to accommodate and support the battery cells 100.

The battery cell array 10 according to an embodiment of the present disclosure may form a cell array structure through the battery cells 100, the cooling tube 200, and the side structure unit 300. The side structure unit 300 forming the cell array structure may guide the battery cell array 10 to be configured without a separate cover structure such as a conventional module frame, thereby implementing a so-called module-frameless structure, and thus the battery cell array 10 may be slimmer and its energy density may be increased.

Referring to FIG. 14 and Tables 3 to 5 again, it is shown that maintaining a flat cell attachment surface 207 during the pressing process is important to ensure optimal cooling performance. Deformation may reduce the contact area with the battery cell, which may reduce heat transfer efficiency. Specifically, the hollow shape of the cooling channel 250 makes it susceptible to deformation during pressing, which affects the external surfaces 207, 209 of the cooling tube 200. To minimize this deformation and reduce pressure loss, the design of the cooling channel is important. A configuration having five inlet channels and five outlet channels (ten channels in total) and specific dimensions, such as a tube thickness of 2.5 mm, an interval between adjacent tubes of 4 mm, and a compression distance of 6.44 mm, may help achieve this. Optimal dimensions for minimal deformation include a cooling channel width (h) of 1.76 mm, a length (w), and an interval (t).

Simulations disclosed in this embodiment show that reducing the width (h) reduces deformation, and that the interval (t) between the channels significantly influences deformation. These design parameters may ensure that the cooling tube maintains structural integrity and efficient thermal management.

In the battery cell array 10, the side structure unit 300 may support the battery cells and enhance their rigidity. This design may form a cell array structure without a separate module frame, thereby slimming down the battery cell array and increasing its energy density. The design of the cooling tube 200 may minimize pressure loss and energy consumption for cooling, thereby promoting more efficient battery operation.

In another embodiment, optimization of the rib thickness and channel geometry may be performed not only to reduce deformation during bending but also to tune the mechanical strength of the cooling tube against vibration or shock experienced in vehicle environments. For example, while a rib thickness of 0.34 mm provides reduced pressure loss, slightly greater rib thicknesses may be employed at selected locations to increase rigidity without substantially affecting coolant flow. Likewise, channel aspect ratios may be varied within the allowable ranges along the length of the cooling tube to locally increase structural stiffness or adjust flow dynamics. These design variations allow the cooling tube to be customized for specific applications, such as electric vehicles subjected to road-induced vibrations or stationary energy storage systems where long-term dimensional stability is prioritized.

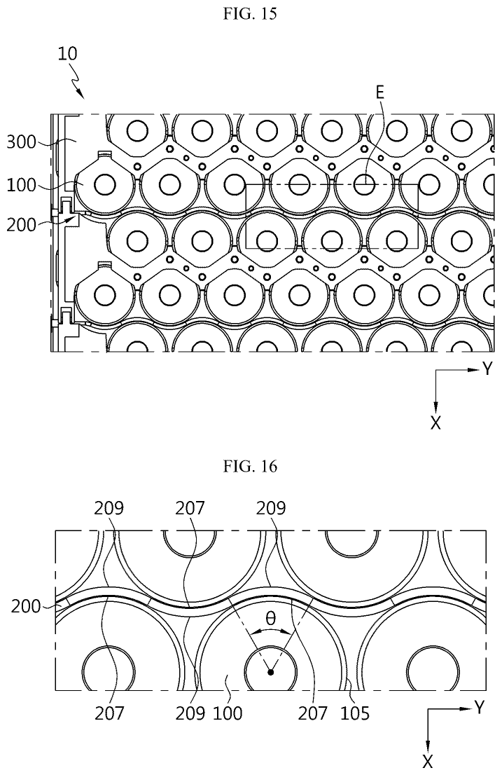

FIG. 15 is a schematic plan view showing a battery cell array for illustrating the arrangement of cooling tubes of the battery cell array according to an embodiment of the present disclosure, and FIG. 16 is an enlarged view of portion E of FIG. 15.

Referring to FIGS. 15 and 16, in the battery cell array 10, the cooling tubes 200 may be arranged between the battery cells 100, which are arranged in two rows, respectively. Each cooling tube 200 may include a cell attachment surface 207 that is formed concavely and is attached to the outer surface 105 of the battery cell 100, and a cell non-attachment surface 209 that is not attached to the outer surface of the battery cell 100 and is formed convexly.

The cell attachment surface 207 and the cell non-attachment surface 209 are alternately formed along the length direction (Y-axis direction) of the cooling tube 200 based on one side (+X-axis direction) or the other side (−X-axis direction) of the cooling tube 200, and may be formed at zigzag positions along the length direction (Y-axis direction) of the cooling tube 200 based on both sides (X-axis direction) of the cooling tube 200. That is, if one side (+X-axis direction) in the thickness direction (X-axis direction) of the cooling tube 200 is the cell attachment surface 207, the other side (−X-axis direction) opposite to the one side (+X-axis direction) may be the cell non-attachment surface 209.

The contact angle (θ) between the battery cells 100 and the cooling tube 200 may be set to approximately 60 degrees or thereabouts. The reason why the contact angle (θ) is set to approximately 60 degrees is that if the contact angle (θ) is greater than 60 degrees, the cooling performance may improve, but there is a problem that the size of the entire battery pack 1 must increase as the interval between the battery cells 100 increases. In addition, as the contact angle increases, the degree of curvature of the cooling tube 200 inevitably increases. Therefore, if the contact angle (θ) is much greater than 60 degrees, the hydraulic pressure may increase, and the cooling flow may not be smooth. In addition, if the contact angle (θ) is less than 60 degrees, the cooling area of the battery cells 100 in contact with the cooling tubes 200 may decrease, which may decrease cooling efficiency.

Therefore, considering this, it is desirable that the contact angle (θ) is arranged within a range of approximately +/−1.5 degrees with respect to 60 degrees. For example, the contact angle (θ) may be arranged within a range of 58.5 degrees to 61.5 degrees.

In another embodiment, the cooling tubes may be provided in modular segments that can be selectively positioned between rows of battery cells to accommodate arrays of different sizes and geometries. For example, in large cell arrays, multiple cooling tubes may be arranged in parallel across adjacent rows of cells, while in smaller arrays, fewer cooling tubes may be used with increased spacing. Each modular cooling tube segment may include independent inlet and outlet ports or may be fluidly connected in a manifolded arrangement, enabling the cooling system to be tailored for variable pack architectures. Such modular configurations allow the battery pack designer to adjust the cooling density according to localized heat generation patterns, thereby improving thermal uniformity across the entire pack without significantly altering the fundamental design of the cooling tubes.

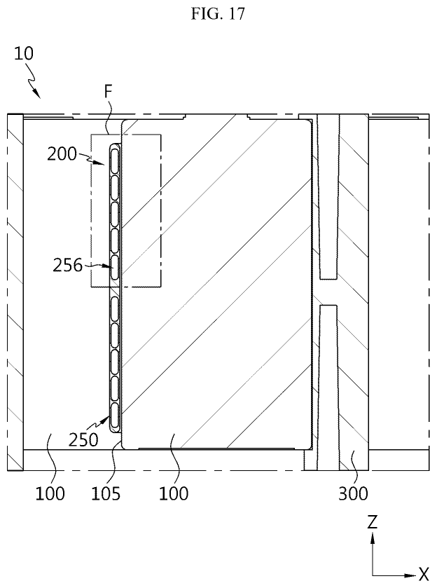

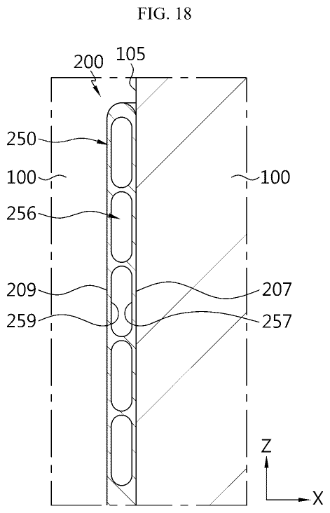

FIG. 17 is a schematic cross-sectional side view showing a battery cell array for explaining the arrangement of the cooling tube in the height direction of the battery cell array according to one embodiment of the present disclosure, and FIG. 18 is an enlarged view showing portion F of FIG. 17.

Referring to FIGS. 17 and 18 along with FIGS. 16 and 17 above, in the battery cell array 10, the cooling tube 200 may secure the cell attachment surface 257 as a flat surface according to the design of the cooling channel 250 described above, thereby increasing the close contact between the cell attachment surface 207 and the outer surface 105 of the battery cells 100 and also forming an internal flow path near the cell attachment surface 207 within the cooling channel 250 without bends, thereby maximizing heat transfer performance.

Meanwhile, the outer surface 105 of the battery cell 100 and the cell attachment surface 207 of the cooling tube 200 may be closely fixed to each other using an adhesive. The adhesive may be, for example, a resin adhesive. In addition, a heat transfer pad having high adhesive strength may be provided between the outer surface 105 of the battery cell 100 and the cell attachment surface 207 of the cooling tube 200. In addition, a filler member made of a resin material may also be filled between the outer surface 105 of the battery cell 100 and the cell attachment surface 207 of the cooling tube 200 to form adhesive strength.

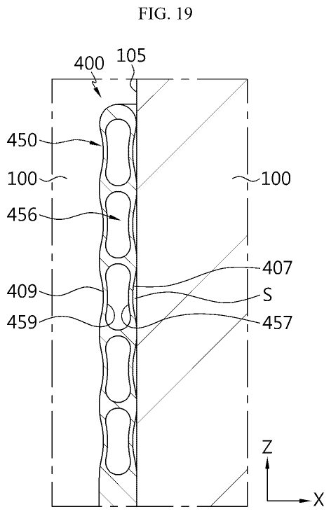

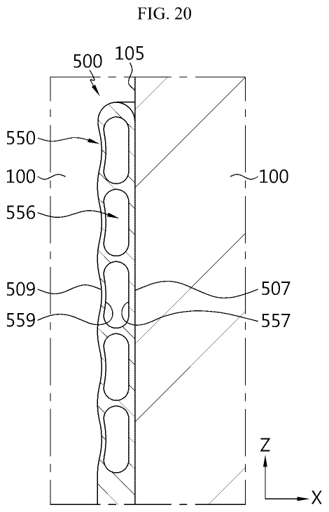

FIGS. 19 and 20 are drawings for illustrating the contact between a cooling tube and a battery cell when deformation occurs in the cooling channel of the cooling tube according to an embodiment of the present disclosure.

Referring to FIG. 19, when deformation of the cooling tube 400 occurs due to deformation of the cooling channel 450 of the cooling tube 400, a predetermined space S is generated between the cell attachment surface 407 of the cooling tube 400 and the outer surface 105 of the battery cell 100. The predetermined space S may mean a non-contact space between the cooling tube 400 and the battery cell 100.

If the predetermined space S is generated, the heat transfer performance of the cooling tube 400 inevitably decreases by the amount of reduced contact area. As described above, the predetermined space S may be caused by deformation of the cooling channel 450, particularly deformation of the cooling channel 450 disposed near the cell attachment surface 407 of the cooling tube 400, during the pressing process of the cooling tube 400. In this way, the deformation of the cooling channel 450 disposed near the cell attachment surface 407 and the deformation of the cell attachment surface 407 of the cooling tube 400 caused thereby may cause a deterioration in the cooling performance of the cooling tube 400.

Referring to FIG. 20, the cooling tube 500 according to this embodiment may be formed to have a flat surface only on the cell attachment surface 507 and the inner surface 557 close to the cell attachment surface 507, and to have a predetermined curvature on the cell non-attachment surface 509 and the inner surface 559 relatively far from the cell attachment surface 507. In other words, in this embodiment, the cell attachment surface 507 and the inner surface 557 of the cooling channel 550 close thereto may have a flat surface, and the cell non-attachment surface 509 and the inner surface 559 of the cooling channel 550 close thereto may have a non-flat surface. That is, the cell non-attachment surface 509, which is provided on the opposite side of the cell attachment surface 507 of the cooling tube 500 and does not come into contact with the outer surface 105 of the battery cells 100, may be provided as a non-flat surface with greater deformation than the flat surface of the cell attachment surface 507.

As described above, the cell attachment surface 507 is concavely pressed during the pressing process (see FIG. 5) and is relatively compressed, so that deformation is small, and the cell non-attachment surface 509 is convexly pressed during the pressing process (see FIG. 10) and is relatively elongated compared to the cell attachment surface 207, so that deformation may occur more. In this embodiment, the cell attachment surface 507 that is in contact with the outer surface 105 of the battery cells 100 may be formed as a flat surface, and the cell non-attachment surface 507 that is not in contact with the outer surface 105 of the battery cells 100 may be formed as a non-flat surface that has a greater degree of deformation than the cell attachment surface 507, which is the flat surface.

The cell attachment surface 507 having the flat surface and the cell non-attachment surface 509 having the non-flat surface are alternately formed along the length direction (Y-axis direction, see FIG. 15) of the cooling tube 500 based on one side (+X-axis direction) or the other side (−X-axis direction) of the cooling tube 500, and may be formed at zigzag positions along the length direction (Y-axis direction, see FIG. 15) of the cooling tube 500 based on both sides (X-axis direction) of the cooling tube 500. That is, in this embodiment, the flat surface and the non-flat surface are alternately formed along the length direction (Y-axis direction, see FIG. 15) of the cooling tube 500 based on one side (+X-axis direction) or the other side (−X-axis direction) of the cooling tube 500, and may be formed at zigzag positions along the length direction (Y-axis direction, see FIG. 15) of the cooling tube 500 based on both sides (X-axis direction) of the cooling tube 500.

Since the cell non-attachment surface 509 formed as the non-flat surface does not come into contact with the battery cells 100, unlike the cell attachment surface 507, its flatness is relatively unimportant. Therefore, as in this embodiment, the cooling channel 550 may be designed by considering only deformation prevention of the cell attachment surface 507 and the cooling channel 550 near the cell attachment surface 507 so as to secure the flatness near the cell attachment surface 507. In this way, in this embodiment, even if the cell non-attachment surface 509 that does not come into contact with the battery cells 100 is formed as a non-flat surface, the cell attachment surface 507 that comes into contact with the outer surface 105 of the battery cells 100 is formed as a flat surface, so that the contact performance between the battery cells 100 and the cooling tube 500 may be secured. Therefore, in this embodiment, the cooling tube 500 may be designed by considering only the flatness of the attachment surface with the battery cells 100 during the pressing process of the cooling tube 500, thereby securing relatively more freedom in the design of the cooling tube 500.

In this embodiment, a method for configuring a cooling tube used in a battery pack may be provided, with the goal of optimizing cooling efficiency by minimizing pressure loss and deformation. This method may begin by extending a cooling tube, which is designed to be characterized by length, width, and height dimensions, along its entire length to facilitate the flow of a cooling medium, thereby ensuring a uniform cooling distribution. The next step may be to change both the number of channels (N) and the aspect ratio (D) of each channel. The aspect ratio D may be related to the geometric ratio of the channels, which directly affects the flow dynamics and heat transfer capability of the cooling system. An important part of the method may be to determine the pressure drop ΔP of the entire cooling tube for the change in each of the number of channels N and the aspect ratio D. This pressure drop ΔP may be calculated using the mathematical formula ΔP=f (N, D, L, T), where L is the length of the cooling tube and T is the thickness of the rib separating adjacent channels. This evaluation may be necessary to understand the influence of various configurations on the resistance to the cooling medium flow, which is essential for maintaining efficient cooling performance. The method may also include the step of determining the deformation δ of each channel when the cooling tube is bent to fit the battery array of the battery pack. Here, the deformation δ may be evaluated using the mathematical formula δ=f (N, D, T).

This analysis may ensure that the cooling tube maintains its structural integrity (entireness) and does not damage the contact area necessary for effective cooling. In addition, the method may include the step of determining the optimal relationship between factors such as the number of channels N, the aspect ratio D, and the rib thickness T with respect to the pressure drop ΔP and the deformation δ. The goal of this method is to maximize the cooling efficiency of the defined cooling tube by minimizing both pressure loss and deformation, so that the cooling system may operate effectively under various thermal loads and mechanical stresses. By systematically analyzing and adjusting these parameters, this method may provide a way for designing a cooling tube that provides improved performance for a battery pack, especially in applications where efficient thermal management is important.

FIG. 21 is a schematic drawing for illustrating a battery cell array according to another embodiment of the present disclosure.

Since the battery cell array 20 according to this embodiment is similar to the battery cell array 10 of the former embodiment, features that are substantially identical or similar to the former embodiment will not be described again, and features different from the former embodiment will be described in detail.

Referring to FIG. 21, the battery cell array 20 may include the cooling tube 500 and battery cells 120.

The battery cell 120 may be provided as a square secondary battery. One battery cell 120 or a plurality of battery cells 120 may be provided. Likewise, the cooling tube 500 may also be applied to the battery cell array 20 in which the battery cell 120 is provided as a square secondary battery 120. As in the former embodiment, even if the cell non-attachment surface 509 that does not come into contact with the battery cell 120 is formed as a non-flat surface, the cell attachment surface 507 that comes into contact with the outer surface 125 of the battery cell 120 is formed as a flat surface, so that contact performance between the battery cell 120 and the cooling tube 500 may be secured. Therefore, even in the battery cell array 20 in which the battery cell 120 is provided as a square secondary battery 120 as in this embodiment, the cooling tube 500 may be designed by considering only the flatness of the attachment surface with the battery cell 120 during the pressing process of the cooling tube 500, thereby securing relatively more freedom in the design of the cooling tube 500.

Therefore, according to this embodiment, even in the battery cell array 20 in which the battery cell 120 is provided as a square secondary battery 120, the structure of the cooling tube 500 capable of securing heat transfer performance and minimizing pressure loss may be implemented. In addition, it is also possible for the battery cell array 20 to include the cooling tubes 200, 201, 202, 203 described above, depending on the design.

FIG. 22 is a drawing for illustrating a battery cell array according to still another embodiment of the present disclosure.

Since the battery cell array 30 according to this embodiment is similar to the battery cell array 10 of the former embodiment, features that are substantially identical or similar to the former embodiment will not be described again, and features different from the former embodiment will be described in detail.

Referring to FIG. 22, the battery cell array 30 may include the cooling tube 500 and battery cells 130.

The battery cell 130 may be provided as a pouch-type secondary battery. One battery cell 130 or a plurality of battery cells 130 may be provided. Likewise, the cooling tube 500 may also be applied to the battery cell array 30 in which the battery cell 130 is provided as a pouch-type secondary battery 130. As in the former embodiment, even if the cell non-attachment surface 509 that does not come into contact with the battery cell 130 is formed as a non-flat surface, the cell attachment surface 507 that comes into contact with the outer surface 135 of the battery cell 130 is formed as a flat surface, so that contact performance between the battery cell 130 and the cooling tube 500 may be secured. Therefore, even in the battery cell array 30 in which the battery cell 130 of this embodiment is provided as a pouch-type secondary battery 130, the cooling tube 500 may be designed by considering only the flatness of the attachment surface with the battery cell 130 during the pressing process of the cooling tube 500, thereby securing relatively more freedom in the design of the cooling tube 500.

Therefore, according to this embodiment, even in the battery cell array 30 in which the battery cell 130 is provided as a pouch-type secondary battery 130, the structure of the cooling tube 500 capable of securing heat transfer performance and minimizing pressure loss may be implemented. In addition, it is also possible for the battery cell array 30 to include the cooling tubes 200, 201, 202, 203 described above, depending on the design.

In this way, the design structures of the cooling tubes 200, 201, 202, 203, 500 according to the above embodiments may be applied to all of the cylindrical secondary battery 100, the square secondary battery 120, and the pouch-type secondary battery 130.

Therefore, according to the above embodiments, the cooling tubes 200, 201, 202, 203, 500 that may secure heat transfer performance and minimize pressure loss in all of the cylindrical secondary batteries 100, the prismatic secondary batteries 120, and the pouch-type secondary batteries 130 may be configured and provided.

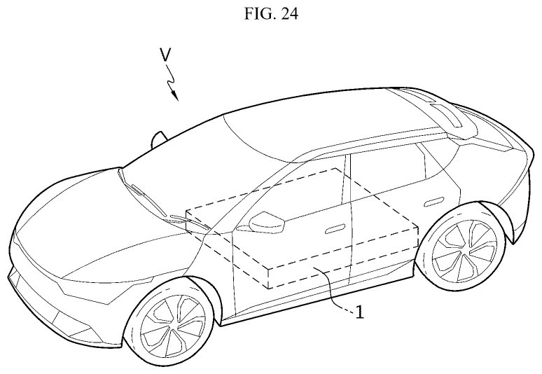

FIG. 23 is a drawing for illustrating a battery pack according to an embodiment of the present disclosure, and FIG. 24 is a drawing for illustrating a vehicle according to an embodiment of the present disclosure.

Referring to FIGS. 23 and 24, the battery pack 1 according to an embodiment of the present disclosure may include at least one of the battery cell array 10, 20, 30 according to the former embodiments and a pack case 50 for accommodating the battery cell array 10, 20, 30.

The battery pack 1 may further include electrical components such as a BMS that controls the battery cell arrays 10, 20, 30, or a cooling unit such as a heatsink for cooling the battery cell arrays 10, 20, 30.

The battery pack 1 according to an embodiment of the present disclosure may further include various other components of the battery pack 1 known at the time of filing of this application. For example, the battery pack 1 according to an embodiment of the present disclosure may further include components such as a current sensor, a fuse, and a service plug.

In addition, a vehicle V according to an embodiment of the present disclosure may include one or more battery packs 1 according to the present disclosure. The vehicle V according to an embodiment of the present disclosure may further include various other components included in the vehicle in addition to the battery pack 1. For example, the vehicle V according to an embodiment of the present disclosure may further include a body, a motor, a control device such as an ECU (electronic control unit), etc. in addition to the battery pack 1 according to an embodiment of the present disclosure.

In addition, it is also possible that the battery pack 1 according to an embodiment of the present disclosure is equipped in other devices, instruments, and facilities, such as an energy storage system using a secondary battery, in addition to the vehicle V.

According to various embodiments as described above, it is possible to provide a battery cell array 10, 20, 30 having a cooling tube 200 capable of securing heat transfer performance and minimizing pressure loss, and a battery pack 1 and a vehicle V including the same.

Moreover, the present disclosure may disclose a cooling tube designed for use in a battery pack. The cooling tube may include a plurality of channels configured to allow a cooling medium to pass therethrough. Each channel of the cooling tube may have an aspect ratio defined by a height and a width. The cooling tube may be designed to be bent to fit the first linear battery arrangement of the battery pack, thereby ensuring that the first side of the cooling tube contacts the battery cells. The number of channels and the aspect ratio of each channel may be specifically designed to maximize the cooling efficiency of the cooling tube. This may be achieved by minimizing the number of channels to reduce pressure drop due to the cooling medium and minimizing deformation of the channels during the bending process.

In other embodiments, further variations of the cooling tube and battery cell array may be implemented to enhance design flexibility and performance. For example, while the cooling tubes 200, 201, 202, 203, and 500 are described as having predetermined channel counts and rib thicknesses, in other embodiments the number of inlet and outlet channels may be dynamically varied across the length of a single cooling tube. In this way, the tube may be configured to provide higher channel density near regions of greater thermal load while reducing channel density in cooler regions of the battery pack, thereby achieving spatially adaptive cooling performance.

In another embodiment, the cross-sectional profile of the channels may be modified beyond the elongated round-ended form shown in FIGS. 9 and 14. For instance, channels may incorporate oval, teardrop, or polygonal cross-sections, provided that the rib thickness and aspect ratios are maintained within the ranges described above to avoid deformation during the pressing process. Such alternative geometries may further tailor pressure drop and enhance mixing of the coolant to promote more uniform heat transfer.

Further, although the cooling tubes are shown bent primarily along the Y-axis direction to conform to linear or multi-row battery arrays (see FIGS. 5-7 and 15-17), the cooling tube may also be configured to include localized bends or undulations along the X-axis direction to better accommodate staggered or offset cell arrangements. For example, in cylindrical cell arrays with hexagonal packing, the cooling tube may incorporate alternating lateral offsets to maintain continuous surface contact with adjacent cells.

The embodiments disclosed herein also contemplate the use of multiple interconnected cooling tubes arranged in parallel or series flow configurations (see FIGS. 15-18). In a parallel arrangement, separate cooling tubes may share a common inlet manifold and outlet manifold, allowing for redundancy and reduced flow resistance. In a series arrangement, coolant may flow sequentially through multiple tubes, increasing dwell time and enabling staged heat removal from different zones of the battery pack. These configurations may be selected depending on the requirements for thermal uniformity, flow efficiency, and packaging constraints.

In some embodiments, the cell-attachment surface of the cooling tube (see FIGS. 19 and 20) may incorporate an adhesive layer, thermal pad, or resin filler with tailored thickness or composition to accommodate variations in cell surface geometry. The filler may include thermally conductive resins or elastomers to ensure reliable long-term contact despite minor deformations during assembly or thermal cycling. By combining mechanical flatness of the tube with compliant thermal interface materials, the effective heat transfer surface area is maximized.

While the cooling medium is described generally as a liquid such as water or dielectric coolant, in other embodiments a two-phase coolant may be used. For instance, the channels may be configured to accommodate refrigerants that undergo phase change within the cooling tube, thereby absorbing latent heat and further reducing peak battery temperatures. Channel shapes and rib thicknesses described herein support such embodiments by resisting deformation even under higher localized pressure differentials associated with boiling.

According to various embodiments as described above, it is possible to provide a cooling tube of a battery pack, which may secure heat transfer performance and minimize pressure loss, and a method for configuring the cooling tube of a battery pack.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

1. A method for configuring a cooling tube of a battery pack, comprising the steps of:
providing a cooling tube with a plurality of channels for a coolant to flow therethrough, the cooling tube defining a length, a width and a height, each channel extending across the length of the cooling tube;
varying a number N of channels and an aspect ratio D of each channel in the cooling tube;
determining a pressure drop ΔP across the cooling tube for each variation in the number N and aspect ratio D of the channels using an equation ΔP=f (N, D, L, T), where L is the length of the cooling tube and T is a thickness of a rib separating adjacent channels;
determining a deformation δ of each channel when the cooling tube is bent to conform to an array of batteries of the battery pack for each variation in the number N and aspect ratio D of channels using an equation δ=f (N, D, T), and
determining a relationship between the number of channels N, aspect ratio of the channels D and the thickness of the rib T with reference to the pressure drop ΔP and deformation δ to maximize a cooling efficiency of the cooling tube,
wherein the cooling efficiency is related to minimizing pressure loss and minimizing deformation.

2. The method of claim 1, wherein the aspect ratio D of each channel is defined by a height and a width of each channel.

3. The method of claim 1, wherein each channel defines an elongated shape with curved upper and lower ends.

4. The method of claim 3, wherein the thickness of each rib T is the minimum distance between adjacent channels.

5. The method of claim 1, wherein the step of bending the cooling tube includes bending the cooling tube to conform to a shape of a first linear array of batteries of the battery pack.

6. The method of claim 5, wherein the cooling tube contacts each of the batteries of the first linear array.

7. The method of claim 6, wherein the cooling tube is configured to be placed between the first linear array and a second linear array of batteries of the battery pack, a first side of the cooling tube contacting the first linear array and a second side of the cooling tube contacting the second linear array.

8. The method of claim 1, wherein the step of determining the pressure drop ΔP includes determining the pressure drop ΔP across the cooling tube for each variation in the number N and aspect ratio D of the channels based on a viscosity and flow rate of the coolant.

9. The method of claim 1, wherein the step of determining a relationship includes determining a relationship between the number of channels N, aspect ratio D of the channels, pressure drop ΔP, and deformation δ using a correlation analysis.

10. The method of claim 1, wherein the plurality of channels including a first set of channels and a second set of channels, the first set of channels for allowing inlet of the coolant into cooling tube and the second set of channel for allowing outlet of the coolant from the cooling tube.

11. The method of claim 10, wherein the cooling tube is configured to include 5 or less channels for each of the first set of channels and the second set of channels, an aspect ratio of each channel being 3.45 or less, and the thickness of the rib being 0.34 mm or less.

12. The method of claim 11, wherein a pressure ΔP per unit length of each channel is less than 6.67 kPa/m for a coolant flow rate of 1 liter/minute.

13. A cooling tube for a battery pack comprising:
a plurality of channels configured to allow coolant to flow through the cooling tube, each channel having an aspect ratio defined by a height and a width,
the cooling tube being bent to conform to a first linear array of batteries of the battery pack such that a first side surface of the cooling tube contacts the first linear array of batteries,
wherein a number of the channels and the aspect ratio of each channel is configured to maximize cooling efficiency of the cooling tube by minimizing the number of channels to minimize pressure drop caused by the coolant and minimize deformation of the channels caused during bending of the cooling tube.

14. The cooling tube of claim 13, wherein the plurality of channels include a first set of channels for inlet of the coolant and a second set of channels for outlet of the coolant.

15. The cooling tube of claim 14, wherein the first set of channels has between 4 and 6 channels and the second set of channels between 4 and 6 channels.

16. The cooling tube of claim 15, wherein the first set of channels has 5 channels and the second set of channels has 5 channels.

17. The cooling tube of claim 16, wherein the aspect ratio of each of the first and second set of channels is 4 or less.

18. The cooling tube of claim 17, wherein the aspect ratio of each of the first and second set of channels is 3.45.

19. The cooling tube of claim 14, wherein a rib is defined between adjacent channels.

20. The cooling tube of claim 19, wherein a thickness of the rib is 0.4 mm or less.

21. The cooling tube of claim 20, wherein the thickness is 0.34 mm.

22. The cooling tube of claim 19, wherein each channel defines an elongate shape with curved upper and lower ends.
